(19) United States
(12) Patent Application Publication
(10) Pub. No.: US 2026/0018173 A1
(43) Pub. Date: Jan. 15, 2026

(54) INFORMATION CONVERSION SYSTEM

(71) Applicant: CANON KABUSHIKI KAISHA, Tokyo (JP)

(72) Inventors: TAIHEI MUKAIDE, Kanagawa (JP); TAKESHI KONDOH, Tokyo (JP)

(21) Appl. No.: 19/335,669

(22) Filed: Sep. 22, 2025

Related U.S. Application Data
(63) Continuation of application No. PCT/JP2024/011185, filed on Mar. 22, 2024.

(30) Foreign Application Priority Data
Mar. 27, 2023 (JP) 2023-050404

(51) Int. Cl. G10L 15/25; G06F 3/01

(52) U.S. Cl. CPC G10L 15/25; G06F 3/015

(57) ABSTRACT

There is provided an information conversion system having an improved conversion accuracy of converting biological information into text information or speech information.

### CROSS-REFERENCE TO RELATED APPLICATIONS

This application is a Continuation of International Patent Application No. PCT/JP2024/011185, filed Mar. 22, 2024, which claims the benefit of Japanese Patent Application No. 2023-050404, filed Mar. 27, 2023, both of which are hereby incorporated by reference herein in their entirety.

### BACKGROUND

### Field of the Technology

The present disclosure relates to an information conversion system for converting biological information into text information or speech information.

### Description of the Related Art

In recent years, user's speech information has been utilized to recognize speech contents. On the other hand, instead of using speech signals, biological signals are obtained to recognize user's facial expression, text information, and the like based on the biological signals, and perform output (e.g., Information Processing Academic Conference Interaction 2020 “Derma: Silent Speech Interaction by Skin movement Measurement”).

In Information Processing Academic Conference Interaction 2020 “Derma: Silent Speech Interaction by Skin movement Measurement”, by using an acceleration sensor and an angular velocity sensor, determination of which phrase is mouthed (silent speech identification) is performed by identifying the phrase based on biological signals regarding a skin movement resulting from a mouth movement for a preset phase.

However, in Information Processing Academic Conference Interaction 2020 “Derma: Silent Speech Interaction by Skin movement Measurement”, data is acquired at a detection rate of 58.3 frames per second (fps), and the measurement data sampling frequency is estimated to be 58.3 Hertz (Hz). If the data sampling frequency is lower than a predetermined value, it may be difficult to achieve sufficient recognition in silent speech recognition.

### SUMMARY

The present disclosure is directed to improving conversion accuracy of an information conversion system for converting biological signals into text information or speech signals.

However, the issue that will be solved by embodiments disclosed in the present specification and accompanying drawings is not limited to the above-described issue. Issues corresponding to different effects by different configurations according to embodiments (described below) can also be considered as other issues.

To achieve the above-described object, an information conversion system includes a biological information detection unit configured to detect biological information from at least one body area of a user, the information conversion system outputting text information or speech information converted from the biological information detected by the biological information detection unit, by using a conversion method, wherein the biological information detection unit is at least either one of an acceleration sensor and an angular velocity sensor, and wherein a sampling frequency of at least either one the acceleration sensor and the angular velocity sensor is more than or equal to 160 Hz.

Features of the present disclosure will become apparent from the following description of embodiments with reference to the attached drawings.

### BRIEF DESCRIPTION OF THE DRAWINGS

FIG. 1 is a diagram illustrating a configuration of an information conversion system of the present disclosure.

FIG. 2 is a flowchart illustrating an operation of the information conversion system of the present disclosure.

FIG. 3 is a diagram illustrating an information conversion system according to a first embodiment of the present disclosure.

FIG. 4 is a schematic view illustrating a detection device according to the first embodiment of the present disclosure.

FIG. 5 is a diagram illustrating a configuration of an information conversion system according to a second embodiment of the present disclosure.

FIG. 6 is a schematic view illustrating a detection device according to the second embodiment of the present disclosure.

FIG. 7 is a diagram illustrating a configuration of an information conversion system according to a third embodiment of the present disclosure.

FIG. 8 is a schematic view illustrating a detection device according to the third embodiment of the present disclosure.

FIG. 9 is a diagram illustrating a configuration of an information conversion system according to a fourth embodiment of the present disclosure.

FIG. 10 is a schematic view illustrating a detection device according to the fourth embodiment of the present disclosure.

FIG. 11 is a diagram illustrating an example of a sampling frequency of a biological signal detection unit of the present disclosure.

FIG. 12 is a diagram illustrating an example of a sampling frequency of a biological signal detection unit of the present disclosure.

### DESCRIPTION OF THE EMBODIMENTS

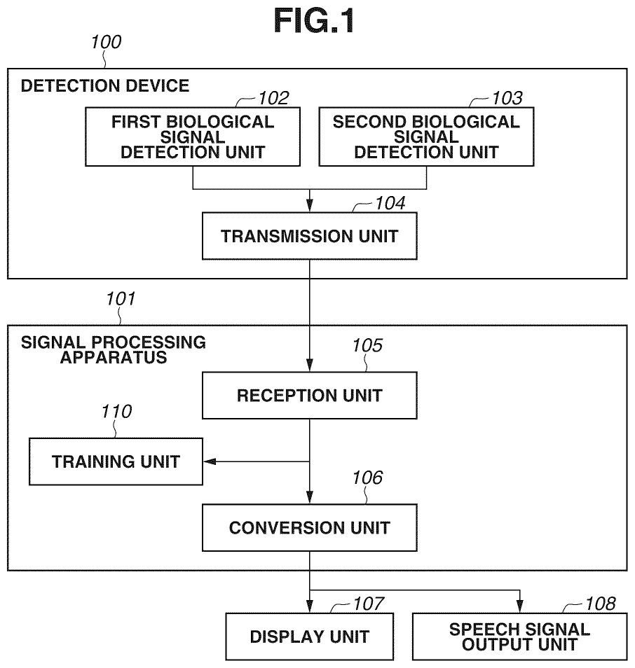

Hereinafter, embodiments of the present disclosure will be described in detail. A schematic diagram of the information conversion system according to the present disclosure is illustrated in FIG. 1.

An information conversion system mainly includes a detection device 100 and a signal processing apparatus 101. The detection device 100 includes a first biological signal detection unit 102 and a second biological signal detection unit 103 for detecting biological signals from at least one body part of a user, and a transmission unit 104 for transmitting the biological signals detected by the first biological signal detection unit 102 and the second biological signal detection unit 103 to the information processing apparatus 101. The first biological signal detection unit 102 and the second biological signal detection unit 103 detect biological signals at different positions or biological signals of different types.

While FIG. 1 illustrates a configuration in which the detection device 100 includes two different biological signal detection units, the detection device 100 may include three or more biological signal detection units. The detection device 100 may have a mechanism for acquiring not only biological signals as well as speech signals. Alternatively, the detection device 100 may be referred to as an acquisition unit for acquiring biological signals.

The first biological signal detection unit 102 and the second biological signal detection unit 103 include sensors for detecting biological signals regarding the motions of the muscles, skin, and tongue of a user. The first biological signal detection unit 102 and the second biological signal detection unit 103 detect biological signals at different positions. Examples of the first biological signal detection unit 102 and the second biological signal detection unit 103 include acceleration sensors for detecting the motions of the mouth and tongue of the user. The first biological signal detection unit 102 and the second biological signal detection unit 103 may be an acceleration sensor and an angular velocity sensor for detecting the motions of the mouth and tongue of the user.

The acceleration sensor detects acceleration and outputs data or a signal corresponding to the detected acceleration. The angular velocity sensor (gyro sensor) detects an angular velocity and outputs data or a signal corresponding to the detected angular velocity. The acceleration sensor and the angular velocity sensor in the first biological signal detection unit 102 and the second biological signal detection unit 103 may be integrated.

The first biological signal detection unit 102 and the second biological signal detection unit 103 are placed on areas where the motions of the mouth and tongue of the user can be detected. The first biological signal detection unit 102 and the second biological signal detection unit 103 are placed around the mouth of the user. More specifically, the first biological signal detection unit 102 and the second biological signal detection unit 103 are placed on areas, such as the user's lower jaw, cheeks, throat, below the ears, and the like. The first biological signal detection unit 102 and the second biological signal detection unit 103 may be placed on areas other than the above-described body parts where biological signal regarding the motions of the mouth and tongue can be detected.

The first biological signal detection unit 102 and the second biological signal detection unit 103 may be an electromyography sensor, ultrasonic sensor, tactile sensor, optical sensor, pressure sensor, and the like. More specifically, the first biological signal detection unit 102 and the second biological signal detection unit 103 may be an acceleration sensor and an angular velocity sensor with a built-in electromyography sensor and pressure sensor. Alternatively, the first biological signal detection unit 102 and the second biological signal detection unit 103 may include a built-in geomagnetism sensor. The first biological signal detection unit 102 and the second biological signal detection unit 103 can also acquire signals regarding motions of the skin and muscles at the same position.

The sampling frequency in the biological signal detection by the first biological signal detection unit 102 and the second biological signal detection unit 103 is more than or equal to a first predetermined value, and more desirably less than or equal to a second predetermined value. For example, the sampling frequency in the biological signal detection by the first biological signal detection unit 102 and the second biological signal detection unit 103 is more than or equal to 160 Hz and less than or equal to 800 Hz.

In a case where the first biological signal detection unit 102 and the second biological signal detection unit 103 have sensors of different types, sampling frequencies of these sensors may be different from each other. The signal processing apparatus 101 includes a reception unit 105 for receiving biological signals transmitted from the detection device 100, and a conversion unit 106 for converting the biological signals received by the reception unit 105 into text information or speech signals.

Although the signal processing apparatus 101 is a smart phone, personal computer (PC), tablet PC, or the like, the present disclosure is not limited thereto. In a case where the signal processing apparatus 101 is a personal computer, for example, the text information converted by the conversion unit 106 is transmitted to a display unit 107, such as a display.

The display unit 107 displays text information. The signal processing apparatus 101 may include a display control unit (not illustrated) for controlling display form of the display unit 107.

The conversion unit 106 can further convert the converted text information into speech signals. Alternatively, the conversion unit 106 can also directly convert biological signals into speech signals. The speech signals converted by the conversion unit 106 are transmitted to a speech signal output unit 108. The speech signal output unit 108 is a speaker and can reproduce speech signals.

When converting the biological signals detected by the first biological signal detection unit 102 and the second biological signal detection unit 103 into text information or speech signals, the conversion unit 106 converts the biological signals into text information or speech signals by using a conversion method.

As a conversion algorithm in the conversion method, a trained model based on a neural network-based architecture is used. The signal processing apparatus 101 includes a storage unit (not illustrated) storing the trained model. The conversion unit 106 has a trained model-based inference function.

The trained model is a model generated by using a Convolutional Neural Network (CNN) and a Recurrent Neural Network (RNN) on a deep learning basis. Models derived from a CNN and RNN are also applicable.

The signal processing apparatus 101 performs learning by associating the biological signals detected by the first biological signal detection unit 102 and the second biological signal detection unit 103 with the text information or speech signals, to generate a trained model for use in the conversion method.

More specifically, the signal processing apparatus 101 pre-acquires a plurality of datasets in which the biological signals detected by the first biological signal detection unit 102 and the second biological signal detection unit 103 is associated with the text information or speech signals (e.g., “a”, “i”, “u”, “e”, and “o”) or corresponding sounds. The first biological signal detection unit 102 and the second biological signal detection unit 103 are placed, for example, at body areas (contact surfaces) where the units are in contact with the skin of the user. The biological signals regarding the user's movement can be measured based on signals from the acceleration sensor and the angular velocity sensor placed on the user.

Referring to FIG. 1, a training unit 110 is included in the signal processing apparatus 101. The training unit 110 may be configured on a cloud. The training unit 110 is an optional component for the signal processing apparatus 101. The signal processing apparatus 101 may include a storage unit for storing a trained model. The configuration of the signal processing apparatus 101 is not limited as long as the trained model can be used.

The training unit 110 pre-acquires a plurality of datasets in which the biological signals detected by the first biological signal detection unit 102 and the second biological signal detection unit 103 is associated with the text information or speech signals. By using, as training data, the correspondence between the biological signals and the text information or speech signals in a plurality of datasets, the training unit 110 performs training by associating the biological signals with the text information or speech signals, to generate the trained model. By using the trained model trained by associating the biological signals with text information in this way, the conversion unit 106 can derive inference from newly input biological signals and output the text information or the speech signals.

By using, as training data, the correspondence between the biological signals and the text information or speech signals in the plurality of datasets and associating the biological signals with the text information or the speech signals, the training unit 110 can also fine-tune the original trained model.

The conversion unit 106 may use different conversion algorithms (trained models) between a silent speech state and a vocalizing state. The silent state is defined as the period when the user is not vocalizing. The vocalizing state refers to the period during which the user is producing vocal sounds.

The training unit 110 distinguishes between the silent speech state and the vocalizing state, and generates separate trained models for each. More specifically, the training unit 110 distinguishes between the silent speech state and the vocalizing state, uses the correspondence between the biological signals and the text information or the speech signals in a plurality of datasets as training data, and performs training by associating the biological signals with the text information or the speech signals, so that respective trained models are generated. The conversion unit 106 applies a trained model for the silent speech state or a trained model for the vocalizing state depending on whether the user is silent or vocalizing. The conversion unit 106 can derive inference from newly input biological signals in the silent speech state or newly input biological signals in the vocalizing state, and output text information or speech signals.

The signal processing apparatus 101 may be configured on a cloud. The transmission unit 104 in the detection device 100 transmits the biological signals detected by the first biological signal detection unit 102 and the second biological signal detection unit 103 to the cloud. The cloud converts the biological signals into text information or speech signals and transmits the converted text information to the display unit 107. The display unit 107 displays the text information. Further, the converted text information may be further converted into speech signals and transmitted to the speech signals output unit 108. Alternatively, the biological signals may be directly converted into speech signals and transmitted to the speech signals output unit 108.

Communication between the detection device 100 and the signal processing apparatus 101 may be wired or wireless. In a case where communication between the detection device 100 and the signal processing apparatus 101 is established via a wired connection, the transmission unit 104 of the detection device 100 and the reception unit 105 of the signal processing apparatus 101 are connected through a wired medium, such as a Universal Serial Bus (USB) cable, or the like.

In a case where communication between the detection device 100 and the signal processing apparatus 101 is established via wireless connection, the transmission unit 104 of the detection device 100 and the reception unit 105 of the signal processing apparatus 101 are connected through wireless Local Area Network (LAN), such as Wi-Fi, or short distance wireless communication, such as Bluetooth®.

In a case where the signal processing apparatus 101 is a smart phone or a tablet PC, the display unit 107 is a display. The speech signals output unit 108 is a speaker installed in a smart phone or a tablet PC, or earphones connected to a smart phone or a tablet PC.

The information conversion system of the present disclosure includes the first biological signal detection unit 102 and the second biological signal detection unit 103 for detecting biological signals from at least one body area of the user, and the conversion unit 106 for outputting text information or speech signals converted from the biological signals detected by the first biological signal detection unit 102 and the second biological signal detection unit 103, by using a conversion method.

The conversion unit 106 can convert the biological signals detected by the first biological signal detection unit 102 and the second biological signal detection unit 103 into text information or speech signals, by using a conversion method.

The conversion unit 106 applies a trained model for the silent speech state or a trained model for the vocalizing state depending on whether the user is either in a silent speech or in a vocalizing. Thus, the conversion unit 106 can switch from a first conversion method to a second conversion method, or from the second conversion method to the first conversion method, depending on whether the user is silent speech or vocalizing, and output text information or speech signals converted by the changed conversion method.

The signal processing apparatus 101 may include a processing unit for evaluating the biological signals detected by the biological signal detection unit 102 and the second biological signal detection unit 103 based on a predetermined evaluation criterion, and then deleting text information or speech signals corresponding to the biological signals not satisfying the predetermined criterion.

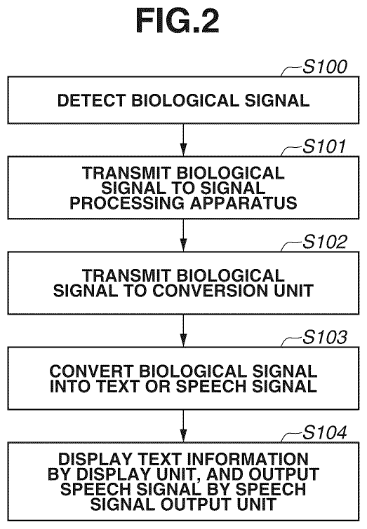

FIG. 2 is a flowchart illustrating an operation of the information conversion system of the present disclosure.

The user wears the detection device 100 at positions where biological signals can be detected by the first biological signal detection unit 102 and the second biological signal detection unit 103. The user wears the detection device 100 on the head, neck, or around the head and neck. The first biological signal detection unit 102 and the second biological signal detection unit 103 detect biological signals including at least one of acceleration signals and angular velocity signals, acceleration signals and angular velocity signals together with a myoelectric potential signal, pressure signals, and the like. In step S100, the sampling frequency of the biological signals in the first biological signal detection unit 102 and the second biological signal detection unit 103 is more than or equal to the first predetermined value (e.g., 160 Hz).

The transmission unit 104 transmits the biological signals to the signal processing apparatus 101. Supplementary information related to time information (timestamp information) is added to the biological signals. In step S101, the transmission unit 104 can transmit the biological signals and the time information to the signal processing apparatus 101.

The biological signals detected by the detection device 100 is received by the reception unit 105 of the signal processing apparatus 101. In step S102, the reception unit 105 transmits the biological signals to the conversion unit 106.

The conversion unit 106 converts the biological signals into text information or speech signals by using a conversion method. The conversion unit 106 may convert the biological signals into speech signals, or the conversion unit 106 may convert the biological signals into text information, and then convert the text information by voice synthesis to acquire speech signals. In step S103, the conversion unit 106 outputs the text information converted from the biological signals.

The display unit 107 displays the text information converted by the conversion unit 106. In step S104, the speech signals output unit 108 outputs the speech signals further converted from the text information converted by the conversion unit 106. The text information converted by the conversion unit 106 can be stored in the storage unit of the signal processing apparatus 101. The text information may also be transferred via a network and then displayed on an external terminal.

The text information may be converted into speech signals, so that the speech signals can be reproduced and recorded by an external terminal, and the user can listen to reproduced voice via earphones.

This allows the user to confirm whether the information has been appropriately converted. The speech signals may be further transferred via a network and then reproduced and recorded by a different external terminal.

An external terminal can be controlled based on the converted text information. Repetitively performing a series of these pieces of processing enables continuous communication using biological signals.

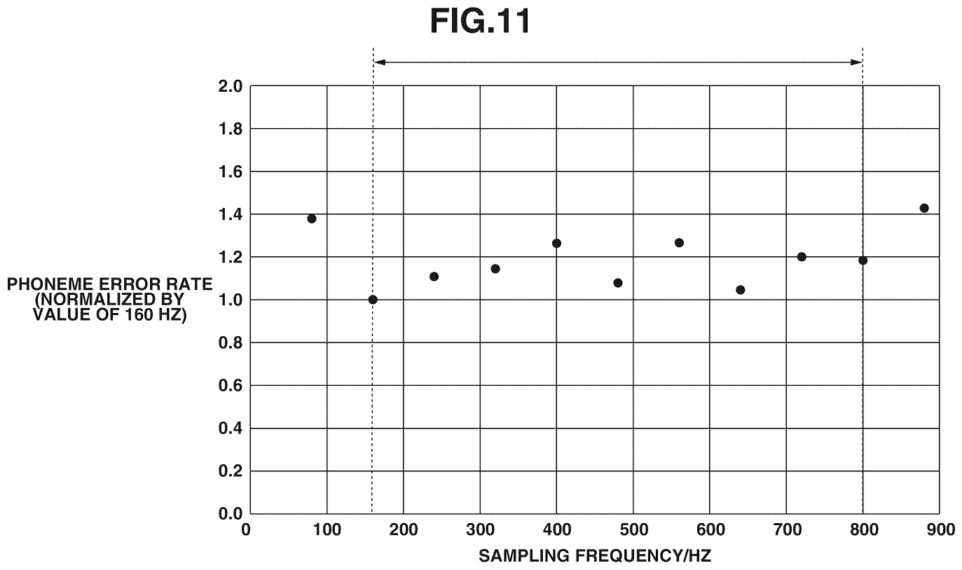

FIG. 11 is a diagram illustrating the sampling frequency in the biological signals detection by the first biological signal detection unit 102 and the second biological signal detection unit 103, and the sampling frequency is more than or equal to the first predetermined value and less than or equal to the second predetermined value. A sampling frequency setting unit (not illustrated) in each of the first biological signal detection unit 102 and the second biological signal detection unit 103 can set the sampling frequency at any frequency.

FIG. 11 illustrates a relation between sampling frequencies for the biological signals and the respective phoneme error rates in the silent speech state. The phoneme error rate refers to the probability of an error occurrence in the text information or speech signals converted from the biological signals through a conversion algorithm (trained model) of the conversion unit 106. A value closer to zero indicates a lower error rate.

Referring to FIG. 11, the phoneme error rate is normalized by setting the error rate at a sampling frequency of 160 Hz to one, and the normalized phoneme error rate is calculated for each 80 Hz sampling frequency.

For example, at a sampling frequency of 80 Hz, the phoneme error rate is about 1.4 which means 1.4 times higher than the phoneme error rate of 1 at the sampling frequency of the 160 Hz. This means that the probability of an error occurrence at the sampling frequency of 80 Hz will be 1.4 times compared to the case at the sampling frequency of 160 Hz. Although not illustrated, there can be a case that the phoneme error rate is twice or more compared to a case at sampling frequencies of 160 Hz or less. This means that the probability of an error occurrence will be twice compared to the case at the sampling frequency of 160 Hz. According to the present embodiment, the phoneme error rate less than or equal to a predetermined multiple (about 1.3 times) is set as a tolerance of the phoneme error rate. Thus, the sampling frequency setting units in the first biological signal detection unit 102 and the second biological signal detection unit 103 set the sampling frequency at 160 Hz as the lower limit.

At sampling frequencies more than 800 Hz, biological signals are small and hence the phoneme error rate tends to increase. Although not illustrated, at sampling frequencies exceeding 800 Hz, the phoneme error rate may be twice or more. At sampling frequencies exceeding 800 Hz, the probability of an error occurrence will be twice compared to the case of the sampling frequency of 160 Hz. Thus, the sampling frequency setting units in the first biological signal detection unit 102 and the second biological signal detection unit 103 set the sampling frequency at 800 Hz as the upper limit.

Since, in a case at high sampling frequencies, a power consumption also tends to large, the range of the sampling frequency may be decreased. More specifically, the sampling frequency setting units in the first biological signal detection unit 102 and the second biological signal detection unit 103 may fix the lower limit of the sampling frequency at 160 Hz, and set the upper limit of the sampling frequency to any sampling frequency. For example, the sampling frequency setting units may set the lower limit of the sampling frequency at 160 Hz, and set the upper limit of the sampling frequency at 500 Hz, and alternatively, set the upper limit of the sampling frequency at 800 Hz.

The transmission unit 104 of the detection device 100 and the reception unit 105 of the signal processing apparatus 101 are wirelessly connected with each other via wireless Local Area Network (LAN), such as Wi-Fi, or short distance wireless communication, such as Bluetooth™.

The sampling frequency in the biological signal detection by the first biological signal detection unit 102 and the second biological signal detection unit 103 may be limited by the communication speed.

Thus, the sampling frequency setting units can also set the upper limit of the sampling frequency in the biological signal detection by the first biological signal detection unit 102 and the second biological signal detection unit 103 according to the type of the communication method that is used by the information conversion system, i.e., the type of the communication method in the detection device 100 and the signal processing apparatus 101. The lower limit of the sampling frequency in the biological signal detection by the first biological signal detection unit 102 and the second biological signal detection unit 103 may also be set according to the type of the communication method that is used by the information conversion system, i.e., the type of the communication method in the detection device 100 and the signal processing apparatus 101.

For example, in Wi-Fi connection, the upper limit of the sampling frequency of the first biological signal detection unit 102 and the second biological signal detection unit 103 is set as a first upper limit value. In Bluetooth® connection, the upper limit of the sampling frequency of the first biological signal detection unit 102 and the second biological signal detection unit 103 is set as a second upper limit value.

The information conversion system of the present disclosure includes the biological signal detection unit 102 (103) for detecting biological signals from at least one body area of the user, and outputs text information or speech signals converted from the biological signals detected by the biological signal detection unit 102 (103) by using a conversion method. The biological signal detection unit 102 (103) is at least either one of an acceleration sensor and an angular velocity sensor, and the sampling frequency of at least either one of the acceleration sensor and the angular velocity sensor is more than or equal to 160 Hz. The sampling frequency of the biological information detection unit 102 (103) is more than or equal to 160 Hz and less than or equal to 800 Hz.

Thus, according to the present disclosure, conversion accuracy of the information conversion system for converting biological signals into text information or speech signals can be improved.

### First Embodiment

### Acceleration Sensor and Angular Velocity Sensor

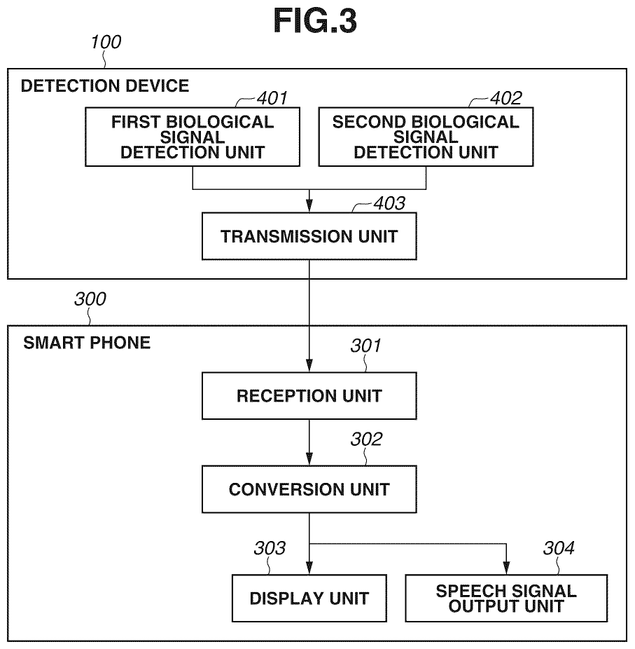

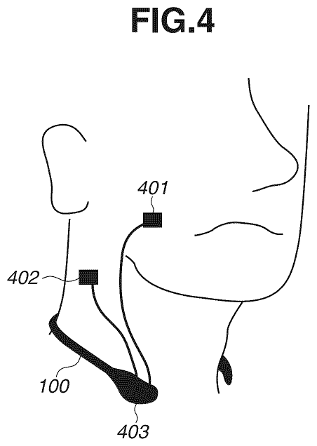

A first embodiment of an information conversion function using the information conversion system of the present disclosure is described. FIG. 3 is a diagram illustrating an overview of the information conversion system of the present disclosure. FIG. 4 is a schematic view illustrating a detection device 100.

Here, a form in which the signal processing apparatus of the information conversion system is a smart phone 300 is described. In the detection device 100, the detection device is supplied with power from a battery (not illustrated). The configuration of the smart phone 300 is similar to the configuration of the signal processing apparatus 101 illustrated in FIG. 1 except for a display unit 303 and a speech signal output unit 304, and the redundant descriptions will be omitted.

As illustrated in FIG. 4, the user wears the detection device 100 on the neck. The detection device 100 having a neckband-shape is worn around the neck of the user. The detection device 100 includes a first biological signal detection unit 401, a second biological signal detection unit 402, and a transmission unit 403. The transmission unit 403 is connected via wired connections to the first biological signal detection unit 401 and the second biological signal detection unit 402. The transmission unit 403 can transmit biological signals detected by the first biological signal detection unit 401 and the second biological signal detection unit 402 to the outside.

The first biological signal detection unit 401 and the second biological signal detection unit 402 are a 6-axis sensor of an acceleration sensor and an angular velocity sensor. For example, the 6-axis sensor of the acceleration sensor and the angular velocity sensor can measure the 3-axis translation acceleration and the 3-axis angular acceleration. The sampling frequency of the first biological signal detection unit 401 and the second biological signal detection unit 402 is set to 160 Hz. The sampling frequency of the first biological signal detection unit 401 and the second biological signal detection unit 402 can be changed to be not less than the first predetermined value, that is, more than or equal to the first predetermined value. The sampling frequency of the first biological signal detection unit 401 and the second biological signal detection unit 402 can be changed to be more than or equal to 160 Hz, for example.

The first biological signal detection unit 401 and the second biological signal detection unit 402 are bonded to a cheek and an area under the ear of the user, with a self-adhesive gel or the like. Thus, the first biological signal detection unit 401 and the second biological signal detection unit 402 can detect biological signals (acceleration, angular velocity, and the like). With this configuration, the first biological signal detection unit 401 and the second biological signal detection unit 402 can detect signals about the movements of user's body parts.

The biological signals detected by the first biological signal detection unit 401 and the second biological signal detection unit 402 are transmitted, for example, to the smart phone 300 via Wi-Fi connection by the transmission unit 403. A reception unit 301 in an application of the smart phone 300 receives data. A conversion unit 302 converts the biological signals received by the reception unit 301 into text information or speech signals by using a trained model. More specifically, the biological signals is converted into text information by using sensor signals on a total of 12-axis obtained from two 6-axis sensors of the acceleration sensor and the velocity sensor as input data of the conversion algorithm.

In generating a trained model according to the present embodiment, 20 different sentences have been acquired 30 times from each of five different users as biological signals in the silent speech state. The acquired data has been split into 80% for training data and 20% for evaluation data. The training has been conducted using the phoneme converted from the sentences based on the training data, as ground truth labels, and a neural network has been trained for 500 epochs, whereby a trained model has been generated.

The text information converted by the conversion unit 302 is displayed on a display serving as the display unit 303 of the smart phone. The speech signals output unit 304 reproduces the speech signals converted by the conversion unit 302.

### Second Embodiment

### Acceleration Sensor, Angular Velocity Sensor, and Electromyography sensor

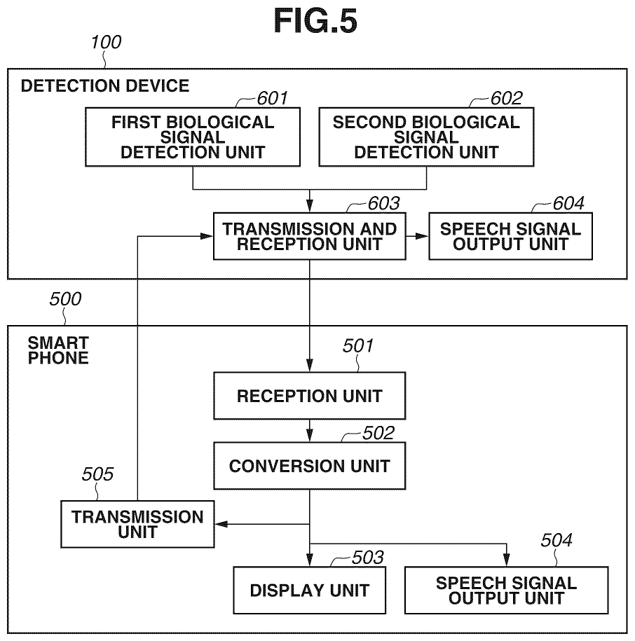

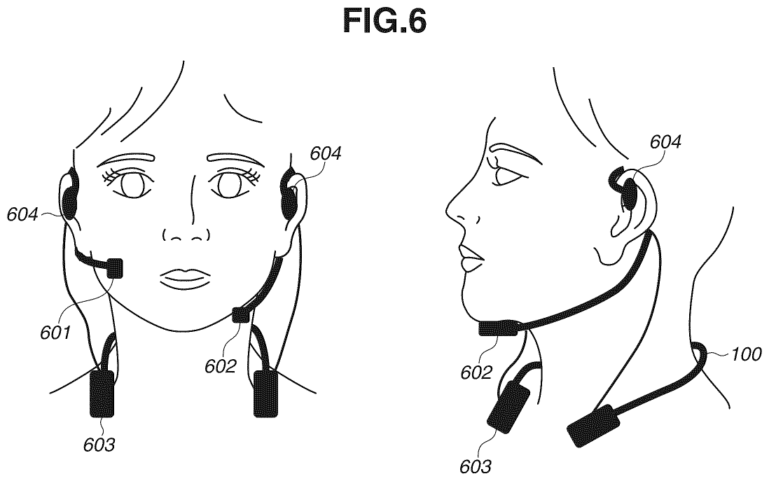

Next, a second embodiment of a text conversion function using the information conversion system of the present disclosure is described below. FIG. 5 is a diagram illustrating an overview of the information conversion system of the present disclosure. FIG. 6 is a schematic view illustrating a detection device 100.

Here, a form in which the signal processing apparatus of the information conversion system is a smart phone 500 is described. In the detection device 100, power is supplied from a battery (not illustrated). The configuration of the smart phone 500 is similar to the configuration of the signal processing apparatus 101 illustrated in FIG. 1 except for a display unit 503, a speech signal output unit 504 and a transmission unit 505, and the redundant descriptions will be omitted.

As illustrated in FIG. 6, the user wears the detection device 100 on the neck and ears. The detection device 100 includes a neckband-shaped member to be worn around the neck of the user, and earphone-shaped members. The neckband-shaped member and the earphone-shaped members are connected with each other via a wired connection. To be worn on the neck of the user, the detection device 100 may be provided with a connecting unit for connecting both ends of a flexible member. The detection device 100 includes a first biological signal detection unit 601, a second biological signal detection unit 602, a transmission and reception unit 603, and speech signal output units 604. The transmission and reception unit 603 is connected with the first biological signal detection unit 601, the second biological signal detection unit 602, and the speech signal output units 604. The transmission and reception unit 603 can transmit the biological signals detected by the first biological signal detection unit 601 and the second biological signal detection unit 602 to the outside.

Further, the transmission and reception unit 603 can receive signals converted by a conversion unit 502, via the transmission unit 505.

The first biological signal detection unit 601 and the second biological signal detection unit 602 are a 6-axis sensor of an acceleration sensor and an angular velocity sensor integrated with an electromyography sensor. For example, the 6-axis sensor of the acceleration sensor and the angular velocity sensor can measure 3-axis translation acceleration and 3-axis angular acceleration. A 3-pole Ag electrode is used for an electrode of the electromyography sensor. The sampling frequency for the biological information is set at 400 Hz for the 6-axis sensor of the acceleration sensor and the angular velocity sensor, and set at 800 Hz for the electromyography sensor. That is, the biological signal detection unit includes a plurality of different sensors, and the sampling frequency setting units can set different sampling frequencies for a plurality of sensors.

The sampling frequencies of the acceleration sensor, the angular velocity sensor, and the electromyography sensor may be different from each other at the time of measurement. Generally, a frequency band of a movement detected by an acceleration sensor and an angular velocity sensor is lower than a frequency band of the myoelectric potential signal, and thus, to more effectively improve the recognition accuracy, it is desirable that the acceleration sensor and the angular velocity sensor should acquire data with a low sampling frequency, and the electromyography sensor should acquire data with a high sampling frequency.

The upper limit of the sampling frequency in the biological signal detection by the first biological signal detection unit 102 and the second biological signal detection unit 103 can be set according to the types of the first biological signal detection unit 601 and the second biological signal detection unit 602.

For example, the acceleration sensor, the angular velocity sensor, and the electromyography sensor may detect biological signals at sampling frequencies of more than or equal to the first predetermined value, and then a specific frequency region may be clipped. The first biological signal detection unit 601 and the second biological signal detection unit 602 are pressed onto a cheek and an under-jaw area of the user by support members extending from the speech signal output units 604. To further enhance wearability, a self-adhesive gel or the like may be used for bonding. With this configuration, the first biological signal detection unit 601 and the second biological signal detection unit 602 can detect biological signals (various accelerations and myoelectric potential). Thus, the first biological signal detection unit 601 and the second biological signal detection unit 602 can detect signals about movements of user's body parts.

The biological signals detected by the biological signal detection units 601 and 602 are transmitted, for example, to the smart phone 500 via Wi-Fi connection by the transmission and reception unit 603. A reception unit 501 in an application of the smart phone 500 receives data. The conversion unit 502 converts the biological signals received by the reception unit 501 into text information or speech signals by using a trained model.

In generating a trained model according to the present embodiment, 20 different sentences have been acquired 30 times from each of five different users as biological signals in the silent speech state. The acquired data has been split into 80% for training data and 20% for evaluation data. The training has been conducted using the phoneme converted from the sentences based on the training data, as ground truth labels, and a neural network has been trained for 500 epochs, whereby a trained model has been generated.

The text information converted by the conversion unit 502 is displayed on a display that is the display unit 503 of the smart phone 500. The speech signals output unit 504 reproduces the speech signals converted by the conversion unit 502. The speech signals converted by the conversion unit 502 can also be transmitted to the detection device 100 by the transmission unit 505, received by the transmission and reception unit 603 of the device, and then reproduced by the speech signal output units 604.

### Third Embodiment

### Acceleration Sensor, Angular Velocity Sensor, and Strain Sensor

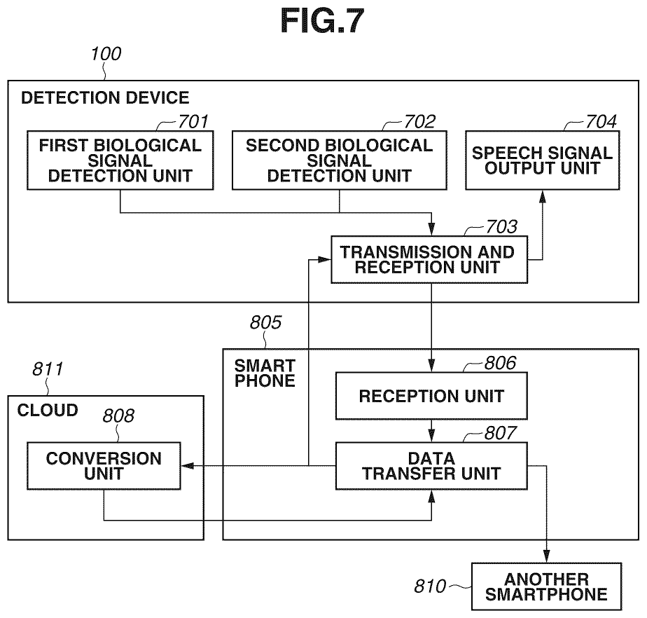

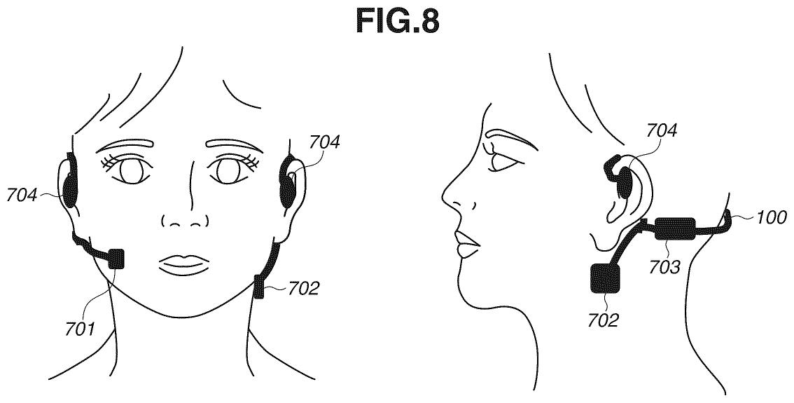

A third embodiment of the information conversion function using the information conversion system of the present disclosure is described. FIG. 7 is a diagram illustrating an overview of the information conversion system of the present disclosure. FIG. 8 is a schematic view illustrating a detection device 100.

The detection device 100 is attached to the user's ears. The detection device 100 includes a first biological signal detection unit 701, a second biological signal detection unit 702, and speech signal output units 704. Each of the first biological signal detection unit 701 and the second biological signal detection unit 702 includes a 6-axis sensor of an acceleration sensor and an angular velocity sensor together with a strain sensor or a 6-axis tactile sensor. The 6-axis tactile sensor can detect forces in the 3-axis directions and moments in the 3-axis directions.

The first biological signal detection unit 701 and the second biological signal detection unit 702 are pressed onto a cheek and an area under the ear of the user. When the first biological signal detection unit 701 and the second biological signal detection unit 702 are brought into contact with the user's skin, the first biological signal detection unit 701 and the second biological signal detection unit 702 can detect biological signals.

A transmission and reception unit 703 is connected with the first biological signal detection unit 701 and the second biological signal detection unit 702. The transmission and reception unit 703 can transmit biological signals detected by the first biological signal detection unit 701 and the second biological signal detection unit 702 to the outside.

The biological signals detected by the first biological signal detection unit 701 and the second biological signal detection unit 702 is wirelessly transferred to a smart phone 805 by the transmission and reception unit 703.

A reception unit 806 in an application of the smart phone 805 receives the biological signals detected by the first biological signal detection unit 701 and the second biological signal detection unit 702. A data transfer unit 807 transfers the biological signals on a cloud 811, and a conversion unit 808 on the cloud 811 converts the biological signals into speech signals by using a trained model.

In generating a trained model according to the present embodiment, 20 different sentences have been acquired 30 times from each of five different users as biological signals in the silent speech state.

The acquired data has been split into 80% for training data and 20% for evaluation data. The learning has been conducted using the phoneme converted from the sentences based on the training data, as ground truth labels, and a neural network has been trained for 500 epochs, whereby a trained model has been generated.

The speech signals converted by the conversion unit 808 are transferred to the data transfer unit 807. The speech signals converted by the conversion unit 808 are transferred to another smart phone 810 and then reproduced. The voice converted at the same time is transferred to the transmission and reception unit 703 via the data transfer unit 807. The transferred voice is reproduced via the speech signal output units 704 such as earphones, allowing the user to confirm the result of the conversion.

### Fourth Embodiment

### Acceleration Sensor and Angular Velocity Sensor

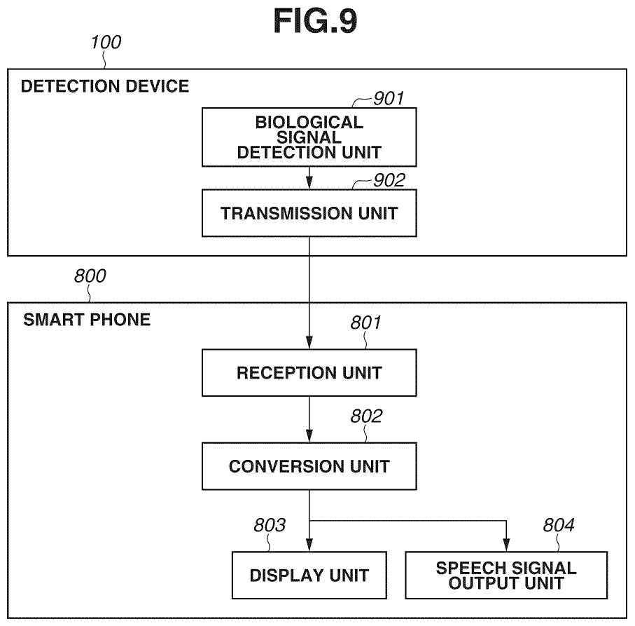

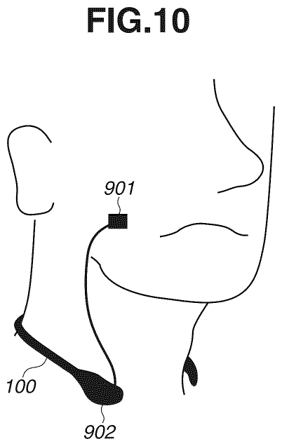

A fourth embodiment of a text conversion function using the information conversion system of the present disclosure is described. FIG. 9 is a diagram illustrating an overview of the information conversion system of the present disclosure. FIG. 10 is a schematic view illustrating a detection device 100.

Here, a form in which the information processing apparatus of the information conversion system is a smart phone 800 is described. In the detection device 100, power is supplied from a battery (not illustrated). The configuration of the smart phone 800 is similar to the configuration of the signal processing apparatus 101 illustrated in FIG. 1 except for a display unit 803 and a speech signal output unit 804, and the redundant descriptions will be omitted.

A transmission unit 902 is connected with a biological signal detection unit 901. The transmission unit 902 can transmit the biological signals detected by the biological signal detection unit 901 to the outside.

The biological signals detected by the biological signal detection unit 901 are wirelessly transferred to the smart phone 800 by the transmission unit 902.

A reception unit 801 in an application of the smart phone 800 receives the biological signals detected by the biological signal detection unit 901. A conversion unit 802 converts the biological signals received by the reception unit 801 into text information or speech signals by using a trained model.

The text information converted by the conversion unit 802 is displayed on a display that is the display unit 803 of the smart phone. The speech signals output unit 804 reproduces the speech signals converted by the conversion unit 802.

### First Comparative Example

A first comparative example of the text conversion function using the information conversion system of the present disclosure is described. An overview of the system is described using FIGS. 9 and 10 which have been used to describe the fourth embodiment.

Here, a form in which the signal processing apparatus of the information conversion system is a smart phone 800 is described. In a detection device 100, power is supplied from a battery (not illustrated). The configuration of the smart phone 800 is similar to the configuration of the information processing apparatus 101 illustrated in FIG. 1 except for a display unit 803 and a speech information output unit 804, and the redundant descriptions will be omitted.

As illustrated in FIG. 10, the user wears the detection device 100 on the neck. The detection device 100 having a neckband-shape is worn around the neck of the user. The detection device 100 includes a biological signal detection unit 901 and a transmission unit 902. The transmission unit 902 is connected with the biological signal detection unit 901 via a wired connection. The transmission unit 902 can transmit the biological signals detected by the biological signal detection unit 901 to the outside.

The biological signal detection unit 901 is a 6-axis sensor of an acceleration sensor and an angular velocity sensor. For example, the 6-axis sensor including the acceleration sensor and the angular velocity sensor can measure 3-axis translation acceleration and 3-axis angular acceleration.

The biological signal detection unit 901 is bonded to a cheek of the user with a self-adhesive gel. Thus, the biological signal detection unit 901 can detect biological signals (various accelerations). With this configuration, the biological signal detection unit 901 can detect signals about movements of user's body parts.

The biological signals detected by the biological signal detection unit 901 is transmitted, for example, to the smart phone 800 via Wi-Fi connection by the transmission unit 902. A reception unit 801 in an application of the smart phone 800 receives data. A conversion unit 802 converts the biological signals received by the reception unit 801 into text or speech signals. More specifically, the biological signals are converted into text information by using sensor signals on a total of 12-axis obtained from two 6-axis sensors of the acceleration sensor and the angular velocity sensor as input data of the conversion algorithm. The text information converted by the conversion unit 802 is displayed on a display that is a display unit 803 of the smart phone 800. The speech signals output unit 804 reproduces the speech signals converted by the conversion unit 802.

Twenty different sentences have been acquired 30 times by the biological signal detection unit 901 from each of five different users as biological signals in the silent speech state. The acquired data has been split into 80% for training data and 20% for evaluation data. The has been conducted using the phoneme converted from the sentences based on the training data, as ground truth labels, and a neural network has been trained for 500 epochs, whereby a trained model has been generated.

FIG. 11 illustrates a relationship between sampling frequencies for the biological signals and the phoneme error rate in the silent speech state. Referring to FIG. 11, with the sampling frequency of 80 Hz for the biological signals, and the evaluation data is subjected to sentence estimation, the phoneme error rate (PER) is about 1.4 times compared to a case at the sampling frequency of 160 Hz, resulting in a degraded recognition accuracy. With the sampling frequency of 160 Hz to 800 Hz for the biological signals, and the evaluation data is subjected to sentence estimation, the phoneme error rate (PER) is about 1.3 times or less compared to a case at the sampling frequency of 160 Hz. With the sampling frequency of 880 Hz for the biological signals, and the evaluation data is subjected to sentence estimation, the phoneme error rate (PER) is about 1.4 times compared to a case of the sampling frequency of 160 Hz, resulting in a degraded recognition accuracy.

### Second Comparative Example

A second comparative example of the text conversion function using the information conversion system of the present disclosure will be described below. The overview of the information conversion system is similar to that of the first comparative example.

Twenty different sentences have been acquired 30 times by the biological signal detection unit 901 from each of five different users as biological signals in the silent speech state.

The acquired data has been split into 80% for training data and 20% for evaluation data. The training has been conducted using the phoneme converted from the sentences based on the training data, as ground truth labels, and a neural network has been trained for 500 epochs, whereby a trained model has been generated.

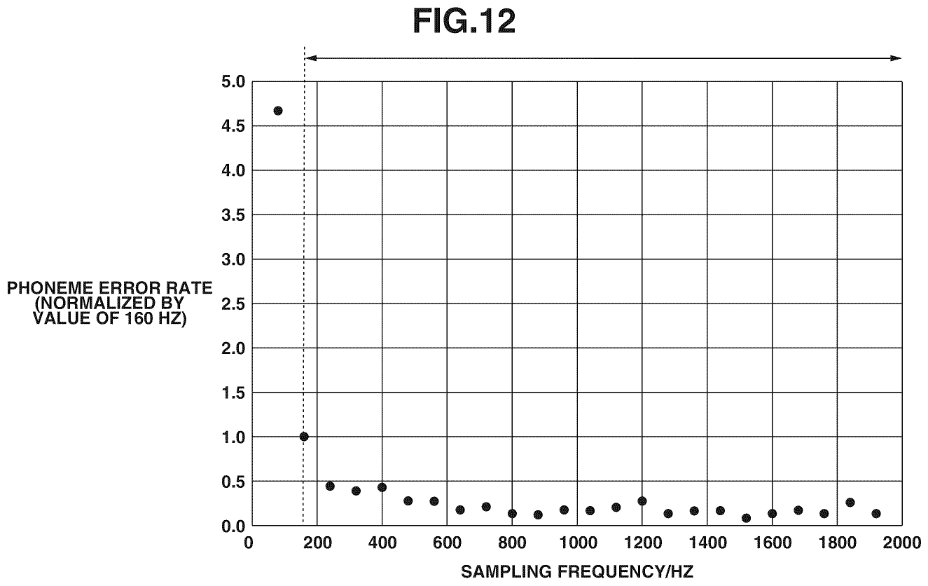

FIG. 12 is a diagram illustrating a relationship between sampling frequencies for the biological signals and the phoneme error rate in the vocalizing state. The phoneme error rate refers to the probability of an error occurrence in the text information or speech signals converted from the biological signals through a conversion algorithm (trained model) of the conversion unit 106. A value closer to zero indicates a lower error rate.

Referring to FIG. 12, the phoneme error rate at the sampling frequency of 160 Hz is normalized to 1, and the normalized phoneme error rate is calculated at intervals of 80 Hz of the sampling frequency.

As illustrated in FIG. 12, with the sampling frequency of 80 Hz for the biological signals, and the evaluation data is subjected to sentence estimation, the phoneme error rate (PER) is about 4.7 times compared to a case at the sampling frequency of 160 Hz, resulting in a degraded recognition accuracy. With the sampling frequency of 160 Hz to 2 kilohertz (kHz) for the biological signals, and the evaluation data is subjected to sentence estimation, the phoneme error rate (PER) is about 1 time or below compared to a case at the sampling frequency of 160 Hz.

The sampling frequency in the biological signal detection by the first biological signal detection unit 102 and the second biological signal detection unit 103 needs to be more than or equal to 160 Hz. More specifically, the lower limit of the sampling frequency is 160 Hz. The upper limit of the sampling frequency may be set to 2 kHz. More specifically, the sampling frequency in the biological signal detection by the first biological signal detection unit 102 and the second biological signal detection unit 103 is less than or equal to 2 kHz.

FIG. 11 illustrates a relationship between the sampling frequency for the biological signals and the phoneme error rate in the silent speech state where the user is silent. FIG. 12 illustrates a relationship between the sampling frequency for the biological signals and the phoneme error rate in the vocalizing state where the user is vocalizing. The characteristics of the phoneme error rate are different between the silent speech state and the vocalizing state.

Thus, the range of the sampling frequency in the biological signal detection by the first biological signal detection unit 102 and the second biological signal detection unit 103 can be differentiated between the silent speech state and the vocalizing state. More specifically, the upper limits of the sampling frequencies in the biological signal detection by the first biological signal detection unit 102 and the second biological signal detection unit 103 are set differently from each other.

In the silent speech state where the user is silent, the range of the sampling frequency in the biological signal detection by the first biological signal detection unit 102 and the second biological signal detection unit 103 is set to 160 Hz to 800 Hz. In the vocalizing state where the user is vocalizing, the range of the sampling frequency in the biological signal detection by the first biological signal detection unit 102 and the second biological signal detection unit 103 is set to 160 Hz to 2 kHz. The sampling frequency in the biological signal detection by the first biological signal detection unit 102 and the second biological signal detection unit 103 is less than or equal to 2 kHz.

A computer program for realizing the functions of the above-described embodiments may be supplied to a computer via a network or a memory (not shown), and executed by a processor (not shown). The computer program is to execute the above-described information conversion method on a computer. In other words, the computer program is a program for realizing the functions of the information conversion apparatus on a computer. The memory stores the computer program.

The present disclosure is not limited to the above-described embodiments, and various modifications and alterations may be made without departing from the spirit and scope of the disclosure. Accordingly, the following claims are appended in order to publicly disclose the scope of the disclosure.

According to the present disclosure, conversion accuracy of an information conversion system for converting biological signals into text information or speech signals is improved.

### Other Embodiments

Embodiment(s) of the present disclosure can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present disclosure has been described with reference to embodiments, it is to be understood that the present disclosure is not limited to the disclosed embodiments. The scope of the following claims is to be accorded the broadest interpretation so as to encompass all such modifications and equivalent structures and functions.

1. An information conversion system comprising:
a biological information detection unit configured to detect biological information from at least one body area of a user, the information conversion system outputting text information or speech information converted from the biological information detected by the biological information detection unit, by using a conversion method,
wherein the biological information detection unit is at least either one of an acceleration sensor and an angular velocity sensor, and
wherein a sampling frequency of at least either one the acceleration sensor and the angular velocity sensor is more than or equal to 160 Hz.

2. The information conversion system according to claim 1, wherein, in a silent speech state where the user is silent, the sampling frequency of at least either one the acceleration sensor and the angular velocity sensor is less than or equal to 800 Hz.

3. The information conversion system according to claim 1, wherein, in a vocalizing state where the user is vocalizing, the sampling frequency of at least either one of the acceleration sensor and the angular velocity sensor is less than or equal to 2 kHz.

4. The information conversion system according to claim 1,
wherein the biological information detection unit includes a first biological information detection unit and a second biological information detection unit, and
wherein the first biological information detection unit and the second biological information detection unit are placed at different body parts of the user.

5. The information conversion system according to claim 4, wherein, in a case where the sensor of the first biological information detection unit and the sensor of the second biological information detection unit are of different types, sampling frequencies of the sensors are different from each other.

6. The information conversion system according to claim 4, wherein the first biological information detection unit and the second biological information detection unit are provided with a sampling frequency setting unit for fixedly setting a lower limit of the sampling frequency at 160 Hz, and optionally setting an upper limit of the sampling frequency.

7. The information conversion system according to claim 6, wherein the sampling frequency setting unit sets the upper limit of the sampling frequency in biological information detection by the first biological information detection unit and the second biological information detection unit according to a communication method type to be used in the information conversion system.

8. The information conversion system according to claim 6, wherein the sampling frequency setting unit sets different upper limits of the sampling frequency in the first biological information detection unit and the second biological information detection units between the silent speech state where the user is silent and the vocalizing state where the user is vocalizing.

9. The information conversion system according to claim 1, wherein the biological information detection unit includes at least either one of the acceleration sensor and the angular velocity sensor, and an electromyography sensor.

10. The information conversion system according to claim 9, wherein the sampling frequency of the electromyography sensor is different from the sampling frequency of at least either one of the acceleration sensor and the angular velocity sensor.

11. The information conversion system according to claim 1, wherein the biological information detection unit includes at least either one of the acceleration sensor and the angular velocity sensor, and at least either one of a pressure sensor and a tactile sensor.

12. The information conversion system according to claim 1, wherein the biological information detection unit is placed on a cheek and an under-jaw area of the user.

13. The information conversion system according to claim 1, wherein the biological information detection unit is placed on a cheek and an under-ear area of the user.

14. An information conversion system comprising:
a biological information detection unit configured to detect biological information from at least one body area of a user, the information conversion system outputting text information or speech information converted from the biological information detected by the biological information detection unit, by using a conversion method, and
wherein a sampling frequency of the biological information detection unit is more than or equal to 160 Hz and less than or equal to 800 Hz.

15. The information conversion system according to claim 14,
wherein the biological information detection unit includes a first biological information detection unit and a second biological information detection unit, and
wherein the first biological information detection unit and the second biological information detection unit are placed at different body parts of the user.

16. The information conversion system according to claim 15, wherein, in a case where the sensor of the first biological information detection unit and the sensor of the second biological information detection unit are of different types, sampling frequencies of the sensors are different from each other.

17. The information conversion system according to claim 15, wherein the first biological information detection unit and the second biological information detection unit are provided with a sampling frequency setting unit for fixedly setting a lower limit of the sampling frequency at 160 Hz, and optionally setting an upper limit of the sampling frequency.
